(19) United States
(12) Patent Application Publication
(10) Pub. No.: US 2003/0200853 A1
(43) Pub. Date: Oct. 30, 2003

(54) Tool element and marking system

(76) Inventor: Andrew G. Gongola, Menomonee Falls, WI (US)

Correspondence Address: MICHAEL BEST & FRIEDRICH, LLP, 100 E WISCONSIN AVENUE, MILWAUKEE, WI, 53202, US

(21) Appl. No.: 10/422,175

(22) Filed: Apr. 24, 2003

Related U.S. Application Data
(60) Provisional application No. 60/375,932, filed on Apr. 26, 2002.

(51) Int. Cl. B26D 7/27

(52) U.S. Cl. 83/522.15

(57) ABSTRACT

Tool elements and methods. In some constructions and in some aspects, a tool element includes a main body and an indicator positioned on the main body for indicating the position of the tool element relative to a workpiece. In some constructions and in some aspects, a tool element is useable with a power tool, which has a guide. The tool element includes a main body connectable to the power tool and an indicator positioned on the main body for indicating the position of the guide relative to the workpiece. In some constructions and in some aspects, a method of manufacturing a tool element includes providing the tool element and producing an indicator on the tool element for indicating the position of the tool element relative to a workpiece.

### RELATED APPLICATIONS

The present application claims the benefit of prior-filed co-pending provisional patent application Serial No. 60/375,932, filed Apr. 26, 2002.

### FIELD OF THE INVENTION

The invention relates to tools and, more particularly, to tool elements, such as saw blades and drill bits.

### BACKGROUND OF THE INVENTION

Power tools, such as reciprocating saws, circular saws, and drills, utilize tool elements, such as reciprocating saw blades, circular saw blades, and drill bits, respectively, therewith to perform an operation, such as sawing or drilling, on a workpiece. It is desirable to properly position the tool element relative to the workpiece so that the operation is performed with the greatest efficiency. Typically, an operator guesses at the proper position of the tool element relative to the workpiece or “eyes-up” the tool element with the workpiece. By using these positioning procedures, the tool element is often not properly positioned relative to the workpiece to perform the operation with the greatest efficiency.

### SUMMARY OF THE INVENTION

Existing tools, such as power tools and hand held tools, typically use tool elements, such as saw blades and drill bits, therewith to perform, in combination, operations, such as cutting, boring, and drilling, on workpieces. Due to the size, shape, and/or material of the workpiece, the operation may need to be performed on the workpiece in a particular manner. In some instances, the tool element may need to be properly aligned with the workpiece to perform an efficient operation or a portion, such as a guide or shoe, of the tool may need to be aligned with the workpiece to perform an efficient operation.

With existing tool elements and tools, an operator must guess or visually line-up the tool element or portion of the tool with the workpiece. This procedure often results in inefficient operations due to the improper alignment of the tool element and/or tool with the workpiece. For example, a saw blade must be properly aligned with a workpiece when the workpiece is a tubular material in which a combination of thin and thick material cross-sections is encountered. Saw blades that cut tubular workpieces have a combination of course and fine teeth defined in an edge thereof for cutting the thick and thin material cross-sections, respectively. An operator must guess or visually line-up the course and fine teeth with the thick and thin cross-sections of the tubular material. This procedure often results in inefficient operations.

The present invention provides a tool element which alleviates one or more independent problems with existing tool elements and tools. In some aspects and in some constructions, the invention provides a tool element that communicates to an end user the ideal alignment of a tool element with a workpiece in order to perform an efficient operation.

More particularly, in some aspects and in some constructions, the invention provides a tool element including a main body and an indicator positioned on the main body for indicating the position of the tool element relative to a workpiece.

In some constructions, the indicator may correspond to a property of the tool element. In other constructions, the indicator may correspond to a property of the workpiece. In further constructions, the indicator may correspond to a type of workpiece material the tool element can perform work upon. In additional constructions, the indicator may indicate a depth into the workpiece that the tool element extends during operation.

In some constructions, the tool element may be a reciprocating saw blade. In other constructions, the tool element may be a circular saw. In further embodiments, the tool element may be a drill bit.

Also, in some aspects and in some constructions, the invention provides a tool element for use with a power tool, which has a guide. The tool element includes a main body connectable to the power tool and an indicator positioned on the main body for indicating the position of the guide relative to the workpiece

In some constructions, the indicator may correspond to a property of the workpiece. In other constructions, the indicator may correspond to a diameter of the work piece and the guide may be positionable at the indicator to position the guide relative to the workpiece and facilitate work to be performed on the workpiece by the tool element and the power tool. In further constructions, the indicator may correspond to a width of the workpiece and the guide may be positionable at the indicator to position the guide relative to the workpiece and facilitate work to be performed on the workpiece by the tool element and the power tool. In additional constructions, the indicator may correspond to a cutting depth into the work piece and the guide may be positionable at the indicator to position the guide relative to the workpiece and facilitate cutting of the workpiece to the cutting depth by the tool element and the power tool.

In some constructions, the tool element may be a reciprocating saw blade and the power tool is a reciprocating saw. In other constructions, the tool element may be a circular saw blade and the power tool may be a circular saw. In further constructions, the tool element may be a drill bit and the power tool may be a drill.

Further, in some aspects and in some constructions, the invention provides a method of manufacturing a tool element. The method includes providing the tool element and producing an indicator on the tool element for indicating the position of the tool element relative to a workpiece.

Independent features and independent advantages of the present invention will become apparent to those skilled in the art upon review of the following detailed description, claims and drawings.

### BRIEF DESCRIPTION OF THE DRAWING

FIG. 1 is a side view of a power tool, such as a reciprocating saw, including a saw blade embodying aspects of the present invention.

FIG. 2 is a side view of the saw blade illustrated in FIG. 1, shown with a workpiece.

FIG. 3 is a partial side view of a first alternate construction of the saw blade illustrated in FIGS. 1 and 2.

FIG. 4 is a partial side view of a second alternate construction of the saw blade illustrated in FIGS. 1 and 2.

FIG. 5 is a partial side view of a third alternate construction of the saw blade illustrated in FIGS. 1 and 2.

FIG. 6 is a partial side view of a fourth alternate construction of the saw blade illustrated in FIGS. 1 and 2.

FIG. 7 is a partial side view of a fifth alternate construction of the saw blade illustrated in FIGS. 1 and 2.

FIG. 8 is a side view of a power tool, such as a circular saw, and a saw blade embodying aspects of the present invention.

FIG. 9 is a partial side view of the saw blade illustrated in FIG. 8.

FIG. 10 is a side view of a drill bit embodying aspects of the present invention.

Before one embodiment of the invention is explained in detail, it is to be understood that the invention is not limited in its application to the details of the constructions and the arrangements of the components set forth in the following description or illustrated in the drawings. The invention is capable of other embodiments and of being practiced or carried out in various ways. Also, it is understood that the phraseology and terminology used herein is for the purpose of description and should not be regarded as limiting.

### DETAILED DESCRIPTION OF THE PREFERRED EMBODIMENT

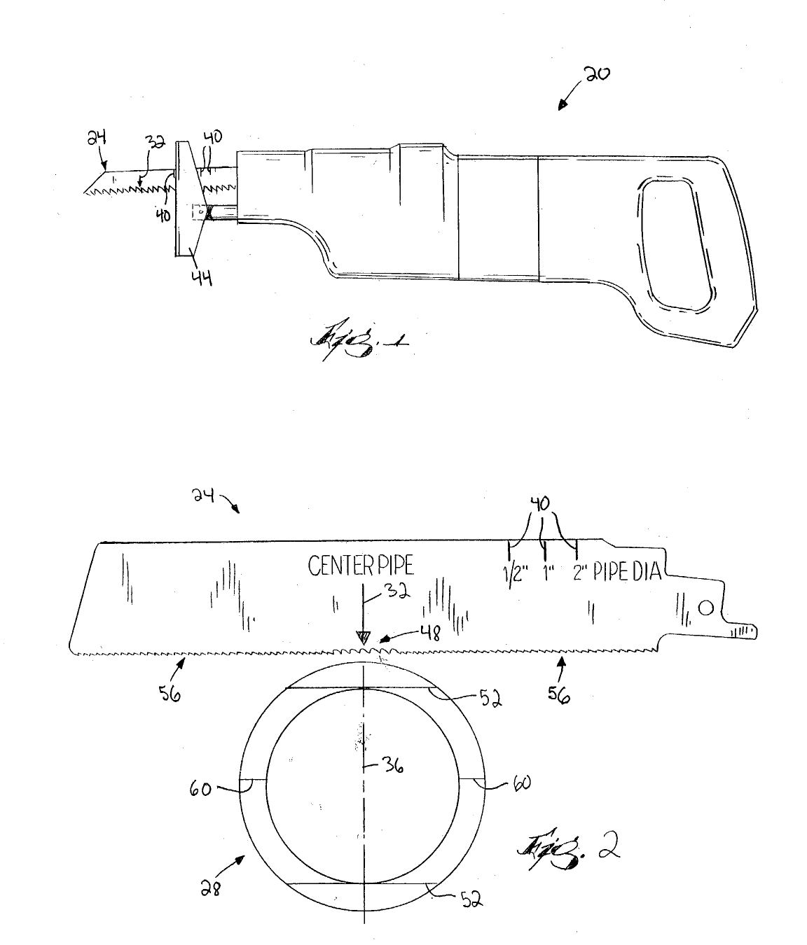

FIG. 1 illustrates a power tool, such as an electric-powered reciprocating saw 20, and a tool element, such as a reciprocating saw blade 24, embodying aspects of the present invention. The electric-powered reciprocating saw 20 is similar to electric-powered reciprocating saws, such as those described in U.S. Pat. Nos. 6,212,781 and 6,249,979, which are hereby incorporated by reference. Although a power tool is described and illustrated, the tool element can be used with other types of tools that are not powered, such as manual hand saws, and still be within the spirit and scope of the present invention.

The saw blade 24 and reciprocating saw 20 operate in combination to perform a reciprocating sawing operation. The reciprocating saw 20 reciprocates the saw blade 24 through a cutting stroke, from an extended position (to the left in FIG. 1) to a retracted position (to the right in FIG. 1), and through a return stroke from the retracted position to the extended position. In between the extended and retracted positions, the saw blade 24 is positioned in a mid-stroke position.

The saw blade 24 includes a marking system for indicating to an operator the proper alignment of the saw blade 24 relative to a workpiece 28 for most efficient cutting in the reciprocating sawing operation. The saw blade 24 includes a workpiece indicator 32, which is alignable with a portion of the workpiece 28, such as the center 36, and shoe position indicators 40, which indicate selected positions of the workpiece guide, such as a reciprocating saw shoe 44. The workpiece indicator 32 and the shoe position indicators 40 can correspond to properties of the workpiece 28, such as, for example, the diameter of a circular workpiece 28, the width of a workpiece 28, the material of the workpiece 28, and the cutting depth into the workpiece 28, or correspond to properties of the saw blade 24, such as, for example the coarseness or fineness of the teeth, the type of saw blade 24, and the stroke length of the saw blade 24. The indicators 32 and 40 may be stamped, punched, carved, painted or otherwise formed on the saw blade 24.

In the construction illustrated in FIG. 2, the saw blade 24 is configured to cut a hollow, cylindrical workpiece 28, such as a pipe. To provide efficient cutting, the saw blade 24 also includes a central set of coarse teeth 48, for cutting the thick cross-section 52 of the center 36 of the workpiece 28 at the start and end of the cutting operation, and two sets of fine teeth 56, for cutting the outer thin cross-sections 60 of the workpiece 28. Such a combination of sets of coarse teeth 48 and fine teeth 56 increase the cutting efficiency of saw blades for pipe cutting operations as described in U.S. Pat. No. 3,805,383, which is hereby incorporated by reference. However, the saw blade illustrated in U.S. Pat. No. 3,805,383 does not include any indications as to the proper positioning of the saw blade relative to the pipe to achieve the efficient cutting benefits of the saw blade design.

In the construction illustrated in FIG. 2, the reciprocating saw shoe 44 is aligned with the selected shoe position indicator 40 corresponding to the diameter of the workpiece 28. The coarse teeth 48 are defined substantially beneath and on both sides of the workpiece indicator 32, and the indicator 32 is preferably aligned with the center 36 of the workpiece 28 when the saw blade 24 is in the mid-stroke position to start cutting.

As the saw blade 24 is reciprocated, the set of coarse teeth 48 cut the thick-cross section 52. The sets of fine teeth 56 are positioned on both sides of the coarse teeth 48 and cut respective outer thin cross-sections 60. Finally, the set of coarse teeth 48 cuts the opposite thick cross-section 52 to complete cutting of the workpiece 28.

Referring to FIG. 3, a first alternate construction of the saw blade 24 is illustrated. With some exceptions (described in greater detail below), the saw blade 24 illustrated in FIG. 3 is similar to the saw blade 24 described above with reference to FIGS. 1-2. Accordingly, reference is made to the above discussion regarding the structure, operation, and alternatives of the saw blade 24 illustrated in FIG. 3, wherein like elements and features of the saw blade 24 illustrated in FIG. 3 have like reference numerals.

In the construction illustrated in FIG. 3, the saw blade 24 is configured to cut a hollow, cylindrical workpiece 28, such as a pipe, similar to the construction of the saw blade 24 illustrated in FIG. 2. Accordingly, the saw blade 24 includes course teeth 48 and two sets of fine teeth 56. In the construction illustrated in FIG. 3, the saw blade 24 includes a course teeth indicator 64, such as the letter “C”, substantially positioned over the center of the course teeth 48 and a plurality of fine teeth indicators 68, such as the letter “F”, one of which is substantially positioned over the center of each set of fine teeth 56. The course teeth indicator 64 is positionable over the thick cross-section 52 of the workpiece 28 and the fine teeth indicators 68 are positionable over the thin cross-sections 60 of the workpiece 28. As the saw blade 24 is reciprocated, the workpiece 28 is cut in a manner similar to that described above with reference to the construction illustrated in FIG. 2.

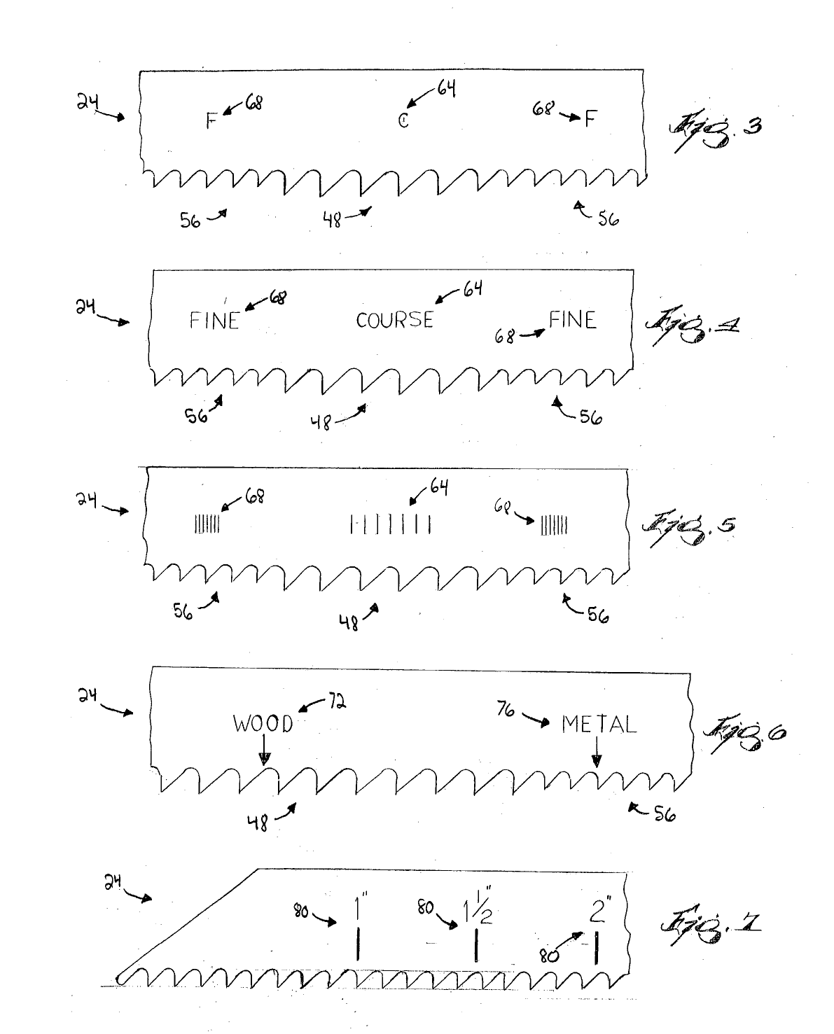

Referring to FIG. 4, a second alternate construction of the saw blade 24 is illustrated. With some exceptions (described in greater detail below), the saw blade 24 illustrated in FIG. 4 is similar to the saw blades 24 described above with reference to FIGS. 1-3. Accordingly, reference is made to the above discussion regarding the structure, operation, and alternatives of the saw blade 24 illustrated in FIG. 4, wherein like elements and features of the saw blade 24 illustrated in FIG. 4 have like reference numerals.

In the construction illustrated in FIG. 4, the saw blade 24 is configured to cut a hollow, cylindrical workpiece 28, such as a pipe, similar to the saw blade 24 constructions illustrated in FIGS. 2-3. Accordingly, the saw blade 24 includes course teeth 48 and two sets of fine teeth 56. In the construction illustrated in FIG. 4, the saw blade 24 includes a course teeth indicator 64, such as the word “COURSE”, substantially positioned over the center of the course teeth 48 and a plurality of fine teeth indicators 68, such as the word “FINE”, one of which is substantially positioned over the center of each set of fine teeth 56. The course teeth indicator 64 is positionable over the thick cross-section 52 of the workpiece 28 and the fine teeth indicators 68 are positionable over the thin cross-sections 60 of the workpiece 28. As the saw blade 24 is reciprocated, the workpiece 28 is cut in a manner similar to that described above with reference to the construction illustrated in FIG. 2.

Referring to FIG. 5, a third alternate construction of the saw blade 24 is illustrated. With some exceptions (described in greater detail below), the saw blade 24 illustrated in FIG. 5 is similar to the saw blades 24 described above with reference to FIGS. 1-4. Accordingly, reference is made to the above discussion regarding the structure, operation, and alternatives of the saw blade 24 illustrated in FIG. 5, wherein like elements and features of the saw blade 24 illustrated in FIG. 5 have like reference numerals.

In the construction illustrated in FIG. 5, the saw blade 24 is configured to cut a hollow, cylindrical workpiece 28, such as a pipe, similar to the saw blade 24 constructions illustrated in FIGS. 2-4. Accordingly, the saw blade 24 includes course teeth 48 and two sets of fine teeth 56. In the construction illustrated in FIG. 5, the saw blade 24 includes a course teeth indicator 64, such as a plurality of substantially parallel vertical lines spaced a first distance from one another, substantially positioned over the center of the course teeth 48 and extending toward the ends of the set of course teeth 48. The saw blade 24 also includes a plurality of fine teeth indicators 68, such as a plurality of substantially parallel vertical lines spaced a second distance from one another. In the construction illustrated in FIG. 5, the first distance is greater than the second distance. Each fine teeth indicator 68 is substantially positioned over the center of each set of fine teeth 56 and extends toward the ends of the sets of fine teeth 56. The course teeth indicator 64 is positionable over the thick cross-section 52 of the workpiece 28 and the fine teeth indicators 68 are positionable over the thin cross-sections 60 of the workpiece 28. As the saw blade 24 is reciprocated, the workpiece 28 is cut in a manner similar to that described above with reference to the construction illustrated in FIG. 2.

It should be understood that the course teeth indicators 64 and the fine teeth indicators 68 can take other shapes and forms from those constructions described above with reference to FIGS. 1-5. Accordingly, course teeth indicators 64 and fine teeth indicators 68 can take any shape or form to indicate the position of course teeth 48 and fine teeth 56, respectively, and therefore, indicate the proper position of the saw blade 24 relative to the workpiece 28.

It should also be understood that the saw blade 24 and power tool, such as the reciprocating saw 20, can be configured to cut other workpieces 28, such as hollow square tubing and hollow rectangular tubing, having thick cross-sections and thin cross-sections for course teeth 48 and fine teeth 56 to cut respectively, or solid workpieces, such as solid pipes, solid boards, and solid rods.

Referring to FIG. 6, a fourth alternate construction of the saw blade 24 is illustrated. With some exceptions (described in greater detail below), the saw blade 24 illustrated in FIG. 6 is similar to the saw blades 24 described above with reference to FIGS. 1-5. Accordingly, reference is made to the above discussion regarding the structure, operation, and alternatives of the saw blade 24 illustrated in FIG. 6, wherein like elements and features of the saw blade 24 illustrated in FIG. 6 have like reference numerals.

In the construction illustrated in FIG. 6, the saw blade 24 is configured to cut multiple types of workpieces 28 having multiple materials, such as wood, metal, and plastic. The saw blade 24 includes multiple types of teeth, such as course teeth 48 and fine teeth 56, corresponding to the type of material to be cut by the teeth. The saw blade 24 can include any number of varying types of teeth to cut any number of varying types of material. In the construction illustrated in FIG. 6, the saw blade 24 includes a set of course teeth 48 for cutting workpieces 28 made of wood and a set of fine teeth 56 for cutting workpieces 28 made of metal. The saw blade 24 also includes a first material indicator 72, such as the word “WOOD” and a substantially vertical downward pointing arrow, substantially positioned over the center of the course teeth 48 for indicating the teeth to be used when performing cutting operations on workpieces 28 made of wood, and a second material indicator 76, such as the word “METAL” and a substantially vertical downward pointing arrow, substantially positioned over the center of the fine teeth 56 for indicating the teeth to be used when performing cutting operations on workpieces 28 made of metal. Accordingly, cutting operations are properly performed with increased efficiency by positioning the appropriate teeth of the saw blade 24, via the material indicators 72, 76, relative to the workpiece 28 to be cut.

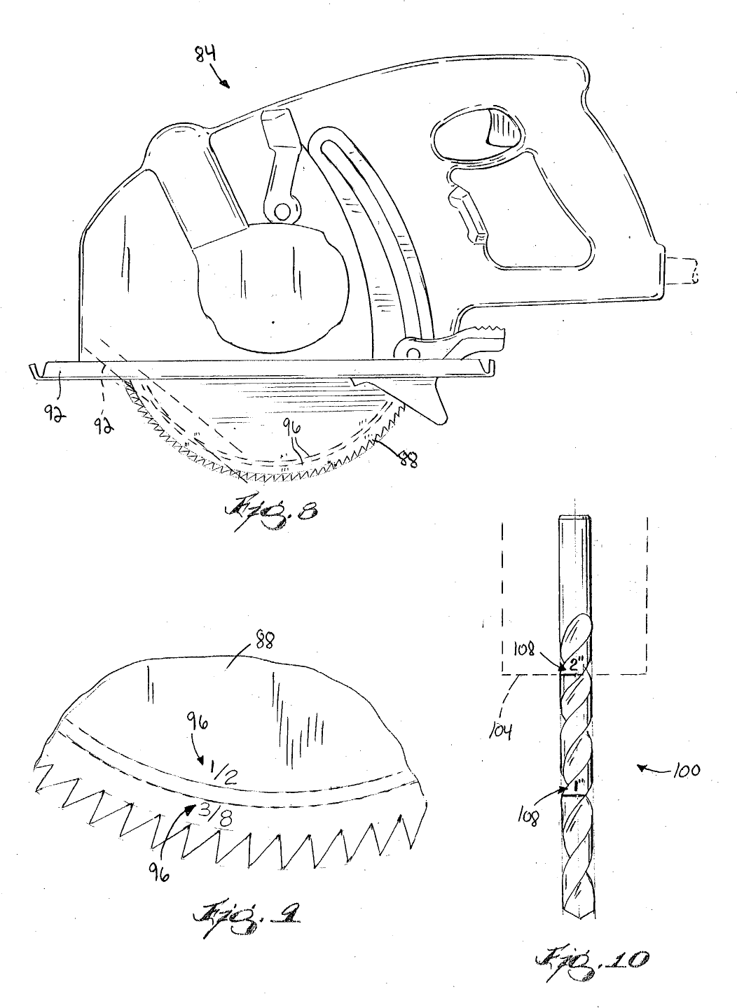

Referring to FIG. 7, a fifth alternate construction of the saw blade 24 is illustrated. With some exceptions (described in greater detail below), the saw blade 24 illustrated in FIG. 7 is similar to the saw blades 24 described above with reference to FIGS. 1-6. Accordingly, reference is made to the above discussion regarding the structure, operation, and alternatives of the saw blade 24 illustrated in FIG. 7, wherein like elements and features of the saw blade 24 illustrated in FIG. 7 have like reference numerals.

In the construction illustrated in FIG. 7, the saw blade 24 is configured to cut a variety of workpieces 28 and to position the saw blade 24 relative to the workpieces 28. The saw blade 24 also includes a plurality of cutting depth indicators 80 to indicate a cutting depth of the saw blade 24. The cutting depth indicators 80 are spaced from one another at any appropriate increment, such as by quarter inches, half inches, inches, or any other appropriate English or metric increments. In the construction illustrated in FIG. 7, the saw blade 24 includes three cutting depth increments, such as “1″”, “1½″”, and “2″”, spaced at half inch increments.

The workpiece 28 can be cut at one of the desired depths in a variety of manners. An operator can position the desired cutting depth indicator 80 at an edge of a workpiece 28 with the portion of the saw blade 24 between the desired cutting depth indicator 80 and the tip of the saw blade 24 positioned over the workpiece 28. The operator can then manually move the saw blade 24 through the workpiece 28 and manually maintain alignment of the desired cutting depth indicator 80 with the edge of the workpiece 28. Alternatively, the shoe 44 of the reciprocating saw 20 can be aligned with the desired cutting depth indicator 80 and the shoe 44 can be pressed against the edge of the workpiece 28. The operator can then move the saw blade 24 through the workpiece 28 while maintaining contact between the shoe 44 and the edge of the workpiece 28. This ensures that the workpiece 28 is cut with a substantially uniform cutting depth throughout.

It should be understood that the saw blade 24 described above with reference to FIG. 7 can include any number of cutting depth indicators 80 and can have any increment of spacing between the cutting depth indicators 80. Accordingly, the cutting depth indicators 80 and increments described above and illustrated in FIG. 7 are for exemplary purposes only.

It should also be understood that, in other constructions (not shown), the indicators 32, 40, 64, 68, 72, 76, 80 may be used to indicate different properties, such as the proper cutting alignment of the saw blades 24 when the saw blades 24 are in the extended or retracted position.

It should further be understood that, in other constructions (not shown), the indicator 32, 40, 64, 68, 72, 76, 80 may be used to indicate different properties, such as, for example, the selected stroke length of the saw blades 24.

FIG. 8 illustrates a power tool, such as an electric-powered circular saw 84, and a tool element, such as a circular saw blade 88, embodying aspects of the present invention. The electric-powered circular saw 84 is similar to the electric-powered circular saw described in U.S. Pat. No. 6,301,789, which is hereby incorporated by reference.

The saw blade 88 and circular saw 84 operate in combination to perform a circular sawing operation. The saw blade 88 includes a plurality of teeth defined in a perimeter thereof and is rotateable by the circular saw 84 to cut a workpiece 28 positioned underneath a guide or shoe 92 of the circular saw 84. The circular saw 84 is advanced along a workpiece 28 and the shoe 92 slides along the top of the workpiece 28 to provide vertical support to the circular saw 84.

In the construction illustrated in FIGS. 8-9, the saw blade 88 includes a marking system for indicating to an operator the proper alignment of the saw blade 88 relative to the workpiece 28 for uniform cutting depth in the circular cutting operation. The saw blade 88 includes a plurality of cutting depth indicators 96 concentrically disposed around the saw blade 88 and incrementally spaced from one another. In the construction illustrated in FIGS. 8-9, the cutting depth indicators 96 are disposed on the saw blade 88 to facilitate a three-eighths inch cut and a half inch cut in a workpiece 28 and are incrementally spaced one-eighth of an inch from one another.

To perform a cutting operation at a desired cutting depth, the saw blade 88 is positioned in the circular saw 84 so that the bottom surface (or surface that is engageable with the workpiece 28) of the shoe 92 is substantially tangential to the desired cutting depth indicator 96. In other words, the desired cutting depth indicator 96 will not substantially extend below the bottom surface of the shoe 92 when the desired cutting depth indicator 96 and the shoe 92 are properly aligned.

It should be understood that the saw blade 88 described above with reference to FIGS. 8-9 can include any number of cutting depth indicators 96 and can have any increment of spacing between the cutting depth indicators 96, including both English and metric increments.

It should also be understood that the saw blade 88 described above with reference to FIGS. 8 and 9 can include other indicators that correspond to things other than cutting depth. These other indicators can correspond to properties of the workpiece 28, such as, for example, the diameter of a circular workpiece 28, the width of a workpiece 28, and the material of the workpiece 28, or correspond to properties of the saw blade 24, such as, for example the coarseness or fineness of the teeth, the type of saw blade 24, and the stroke length of the saw blade 24.

FIG. 10 illustrates a tool element, such as a drill bit 100, embodying aspects of the present invention. The drill bit 100 is operable in combination with a drill, such as a manual drill and an electric-powered drill (not shown), such as those described in U.S. Pat. Nos. 6,102,633, 4,682,918 and 4,229,981, which are hereby incorporated by reference. The drill includes a chuck 104 (shown in phantom in FIG. 10), which is operable to connect the drill bit 100 to the drill.

The drill bit 100 and drill operate in combination to perform a boring or drilling operation. The drill rotates the drill bit 100 to cut or bore a hole in a workpiece 28 and is advanced to bore deeper into the workpiece 28 by applying a force on the drill in the desired advancing direction.

In the construction illustrated in FIG. 10, the drill bit 100 includes a marking system for indicating to an operator the proper alignment of the drill bit 100 relative to the workpiece 28 and the drill. The marking system also assists in producing uniform bore depths during drilling operations. The drill bit 100 includes a plurality of boring depth indicators 108 incrementally spaced from one another. In the construction illustrated in FIG. 10, the boring depth indicators 108 are disposed on the drill bit 100 to facilitate a one inch bore and a two inch bore in a workpiece 28 and are incrementally spaced one inch from one another.

To perform a boring operation at a desired boring depth, the drill bit 100 is connected to the chuck 104 by inserting the drill bit 100 into the chuck 104 until the desired boring depth indicator 108 is aligned with the outermost surface of the chuck 104 (as shown in phantom in FIG. 10). The chuck 104 is then tightened around the drill bit 100 to secure the drill bit 100 to the drill. Alternatively, the drill can include a depth locator or other device (not shown) surrounding the drill bit 100 and extending toward the tip of the drill bit 100. The depth locator is aligned with the desired boring depth indicator 108 rather than the chuck 104. The drill bit 100 is biased against a workpiece 28 and appropriately bores into the workpiece 28 until the outermost surface of the chuck 104 or the depth locator engages the workpiece 28. Upon engagement between the chuck 104 or depth locator and the workpiece 28, a bore is bored into the workpiece 28 by the drill bit 100 to the desired boring depth. An operator can alternatively visually inspect the boring operation and terminate the boring operation when the desired boring depth indicator 108 is flush with the surface of the workpiece 28.

It should be understood that the drill bit 100 described above with reference to FIG. 10 can include any number of boring depth indicators 108 and can have any increment of spacing between the boring depth indicators 108, including both English and metric increments.

It should also be understood that the drill bit 100 described above with reference to FIG. 10 can include other indicators that correspond to things other than boring depth. These other indicators can correspond to properties of the workpiece 28, such as, for example, the diameter of a circular workpiece 28, the width of a workpiece 28, and the material of the workpiece 28, or correspond to properties of the drill bit 100, such as, for example the size of the drill bit 100 and the type of drill bit 100.

In addition, it should be understood that, in other constructions (not shown), additional indicators (not shown) may be provided to indicate different conditions as necessary for a given operation, whether the operation be cutting, drilling, or any other operation performed by a power tool.

Although particular constructions of the present invention have been shown and described, other alternate constructions will be apparent to those skilled in the art and are within the intended scope of the present invention. Thus, the present invention is to be limited only by the claims.

1. A tool element comprising:
a main body; and
an indicator positioned on the main body for indicating the position of the tool element relative to a workpiece.

2. The tool element of claim 1, wherein the indicator is positioned on the main body to align a portion of the tool element with a center of the workpiece.

3. The tool element of claim 1, wherein the indicator corresponds to a property of the tool element.

4. The tool element of claim 1, wherein the indicator corresponds to a property of the workpiece.

5. The tool element of claim 4, wherein the indicator corresponds to a type of workpiece material the tool element can perform work upon.

6. The tool element of claim 1, wherein the indicator indicates a depth into the workpiece that the tool element extends during operation.

7. The tool element of claim 1, wherein the tool element is connectable to a power tool having a guide, and wherein the indicator is a first indicator, the tool element further comprising a second indicator positioned on the main body for indicating the position of the guide relative to the workpiece.

8. The tool element of claim 7, wherein the second indicator corresponds to a property of the workpiece.

9. The tool element of claim 8, wherein the second indicator corresponds to the diameter of the workpiece.

10. The tool element of claim 8, wherein the second indicator corresponds to the width of the workpiece.

11. The tool element of claim 1, wherein the tool element is a reciprocating saw blade.

12. The tool element of claim 11, wherein the reciprocating saw blade includes course teeth and fine teeth defined in an edge of the reciprocating saw blade, the fine teeth being disposed on both sides of the course teeth, the indicator being positioned on the main body to align the course teeth with a center of the workpiece.

13. The tool element of claim 12, wherein the indicator is a first indicator, the reciprocating saw blade further comprising a second indicator and a third indicator, the first indicator being positioned over the course teeth to indicate the position of the course teeth, the second indicator and the third indicator each being respectively positioned over the fine teeth disposed on both sides of the course teeth to indicate the position of the fine teeth.

14. The tool element of claim 13, wherein the first indicator is a letter C, the second indicator is a letter F, and the third indicator is a letter F.

15. The tool element of claim 13, wherein the first indicator is a word COURSE, the second indicator is a word FINE, and the third indicator is a word FINE.

16. The tool element of claim 13, wherein the first indicator is a plurality of substantially parallel vertical lines spaced a first distance from one another and the second indicator and the third indicator are each a plurality of substantially parallel vertical lines spaced a second distance from one another, the first distance being greater than the second distance.

17. The tool element of claim 11, wherein the reciprocating saw blade includes a first set of teeth and a second set of teeth defined in an edge of the reciprocating saw blade, the first set of teeth and the second set of teeth having different sizes compared to one another and being operable to cut a particular type of material, and wherein the indicator is a first indicator positioned over the first set of teeth, the reciprocating saw blade further comprising a second indicator positioned over the second set of teeth.

18. The tool element of claim 17, wherein the first indicator corresponds to the type of material that the first set of teeth is operable to cut and the second indicator corresponds to the type of material that the second set of teeth is operable to cut.

19. The tool element of claim 1, wherein the tool element is a circular saw blade.

20. The tool element of claim 19, wherein the indicator is substantially concentric with a perimeter of the circular saw blade and indicates a cutting depth of the circular saw blade into the workpiece.

21. The tool element of claim 20, wherein the indicator is a first indicator, the circular saw blade further comprising a second indicator substantially concentric with the first indicator and having a smaller diameter than the first indicator, the second indicator indicating a second cutting depth of the circular saw blade into the workpiece, the second cutting depth being greater than the cutting depth.

22. The tool element of claim 1, wherein the tool element is a drill bit.

23. The tool element of claim 22, wherein the drill bit has a longitudinal axis, the indicator being at least partially perpendicular to the longitudinal axis and indicating a cutting depth of the drill bit into the workpiece.

24. The tool element of claim 23, wherein the indicator is a first indicator, the drill bit further comprising a second indicator substantially perpendicular to the longitudinal axis and spaced apart from the first indicator, the second indicator indicating a second cutting depth of the drill bit into the workpiece, the second cutting depth being greater than the cutting depth.

25. The tool element of claim 1, wherein the indicator is stamped into the main body.

26. The tool element of claim 1, wherein the indicator is painted on the main body.

27. The tool element of claim 1, wherein the indicator is carved into the main body.

28. The tool element of claim 1, wherein the indicator is punched into the main body.

29. A tool element for use with a power tool, the power tool having a guide, the tool element comprising:
a main body connectable to the power tool; and
an indicator positioned on the main body for indicating the position of the guide relative to the workpiece.

30. The tool element of claim 29, wherein the indicator corresponds to a property of the workpiece.

31. The tool element of claim 29, wherein the indicator corresponds to a diameter of the work piece, the guide being positionable at the indicator to position the guide relative to the workpiece and facilitate work to be performed on the workpiece by the tool element and the power tool.

32. The tool element of claim 31, wherein the indicator is a first indicator and the diameter is a first diameter, the tool element further comprising a second indicator corresponding to a second diameter of the workpiece, the guide being positionable at either the first indicator or the second indicator to accommodate a workpiece having either the first diameter or the second diameter, respectively.

33. The tool element of claim 29, wherein the indicator corresponds to a width of the workpiece, the guide being positionable at the indicator to position the guide relative to the workpiece and facilitate work to be performed on the workpiece by the tool element and the power tool.

34. The tool element of claim 33, wherein the indicator is a first indicator and the width is a first width, the tool element further comprising a second indicator corresponding to a second width of the workpiece, the guide being positionable at either the first indicator or the second indicator to accommodate a workpiece having either the first width or the second width, respectively.

35. The tool element of claim 29, wherein the indicator corresponds to a cutting depth into the work piece, the guide being positionable at the indicator to position the guide relative to the workpiece and facilitate cutting of the workpiece to the cutting depth by the tool element and the power tool.

36. The tool element of claim 35, wherein the indicator is a first indicator and the cutting depth is a first cutting depth, the tool element further comprising a second indicator corresponding to a second cutting depth into the workpiece, the guide being positionable at either the first indicator or the second indicator to cut the workpiece to either the first cutting depth or the second cutting depth, respectively.

37. The tool element of claim 29, wherein the tool element is a reciprocating saw blade and the power tool is a reciprocating saw.

38. The tool element of claim 29, wherein the tool element is a circular saw blade and the power tool is a circular saw.

39. The tool element of claim 29, wherein the tool element is a drill bit and the power tool is a drill.

40. A method of manufacturing a tool element, the method comprising:
providing the tool element; and
producing an indicator on the tool element for indicating the position of the tool element relative to a workpiece.

41. The method of claim 40, wherein producing an indicator includes stamping the indicator on the tool element.

42. The method of claim 40, wherein producing an indicator includes carving the indicator on the tool element.

43. The method of claim 40, wherein producing an indicator includes punching the indicator in the tool element.

44. The method of claim 40, wherein producing an indicator includes painting the indicator on the tool element.

45. The method of claim 40, wherein the tool element is useable with a power tool having a guide, the method further comprising producing a second indicator on the tool element for indicating the position of the guide relative to the workpiece.

46. The method of claim 40, wherein providing includes providing a reciprocating saw blade.

47. The method of claim 40, wherein providing includes providing a circular saw blade.

48. The method of claim 40, wherein providing includes providing a drill bit.
